(19) United States
(12) Patent Application Publication
(10) Pub. No.: US 2004/0038109 A1
(43) Pub. Date: Feb. 26, 2004

(54) Apparatus for electrically insulating bipolar plates in fuel cell stack

(76) Inventor: John E. Bernacki, Rochester, NY (US)

Correspondence Address: Delphi Technologies, Inc., P.O. Box 5052, Mail Code 480410202, Troy, MI, 48007, US

(21) Appl. No.: 10/225,880

(22) Filed: Aug. 22, 2002

(51) Int. Cl. H01M 8/02

(52) U.S. Cl. 429/35; 429/66

(57) ABSTRACT

An improved perimeter gasket is provided for use with a bipolar plate in a fuel cell assembly. The improved dielectric perimeter gasket comprises a base portion, at means for forming a primary seal with an adjacent bipolar plate, and a flange extending radially from the base portion for assuring that adjacent bipolar plates cannot make electrical contact. The flange may be coextensive with the edges of the bipolar plates. The gasket may be provided integrally with the bipolar plate.

### TECHNICAL FIELD

The present invention is related to fuel cells; more particularly, to proton exchange fuel cells; and most particularly, to apparatus for providing electrical insulation of bipolar plates in a fuel cell stack.

### BACKGROUND OF THE INVENTION

Fuel cell assemblies employing proton exchange membranes are well known. Such assemblies typically comprise a stack of fuel cell modules, each module having an anode and a cathode separated by a catalytic proton exchange membrane, and the modules in the stack being connected in series electrically to provide a desired voltage output. Gaseous fuel, in the form of hydrogen or hydrogen-containing mixtures such as “reformed” hydrocarbons, flows adjacent to a first side of the membrane, and oxygen, typically in the form of air, flows adjacent to the opposite side of the membrane. Hydrogen is catalytically oxidized at the anode-membrane interface, and the resulting proton, H+, migrates through the membrane to the cathode-membrane interface where it combines with anionic oxygen, O⁻², to form water. Protons migrate only in those areas of the fuel cell in which the anode and cathode are directly opposed across the membrane. Electrons flow from the anode through a load to the cathode, doing electrical work in the load.

A fuel cell assembly typically comprises a plurality of fuel cell modules connected in series by mechanical and electrical interconnects, known in the art as “bipolar plates,” to form a fuel cell stack. Bipolar plates typically extend laterally beyond the edges of the fuel cell modules to form manifolds for inlet and exhaust of gases to the fuel cell modules, and are provided with non-conductive polymeric gaskets between adjacent bipolar plates to seal the gas passageways from lateral leakage.

During both manufacture and operation, a fuel cell assembly may be subjected to extreme conditions such as excessive pressure in the stack assembly, warp, variations in plate configurations, or thermal expansion of the plates. Any of these conditions can unduly compress the prior art perimeter gasket, allowing adjacent bipolar plates to come into contact with each other. Since the plates have different electrical charges, contact between the plates will cause an electrical short, resulting in failure of the entire fuel cell assembly.

Merely increasing the thickness of the prior art perimeter gasket does not ameliorate the situation since increasing the gasket thickness makes the gasket more prone to leakage and the plates more prone to cracking from crushing or flexural forces. Consequently, failure of the stack can occur.

Insulative coatings can be applied to the bipolar plates; however, the coatings add an additional step and additional cost to the manufacture of a fuel cell assembly.

What is needed is a means for ensuring that adjoining bipolar plates do not contact one another during assembly or operation of a fuel cell assembly.

It is a principal object of the present invention to fully and automatically ensure that adjacent bipolar plates do not contact one another during assembly or operation of a fuel cell stack.

It is a further object of the present invention to increase the longevity and reliability of a fuel cell stack.

### SUMMARY OF THE INVENTION

Briefly described, an improved perimeter gasket is provided for use with a bipolar plate in a fuel cell assembly. The improved dielectric perimeter gasket comprises a base portion and a flange extending outwardly from the base portion for assuring that adjacent bipolar plates cannot make electrical contact. The flange may be coextensive with the edges of the plates or extend there beyond. In a preferred embodiment at least one rib extends axially of the base portion for forming a primary seal with an adjacent bipolar plate.

### BRIEF DESCRIPTION OF THE DRAWINGS

The present invention will now be described, by way of example, with reference to the accompanying drawings, in which:

FIG. 1 is a top view of a bipolar plate having a known perimeter gasket;

FIG. 2 is a detailed cross-sectional view of a portion of a fuel cell assembly, including the plate and gasket shown in circle 2 in FIG. 1, showing a known non-compressed perimeter gasket disposed between two adjacent bipolar plates;

FIG. 3 is a cross-sectional view of a portion of a fuel cell assembly, showing one embodiment of a non-compressed perimeter gasket in accordance with the invention disposed between two adjacent bipolar plates; and

FIG. 4 is a cross-sectional view of a portion of a fuel cell assembly, showing a perimeter gasket in accordance with the invention disposed between two adjacent bipolar plates and compressed after assembly, thereby preventing electrical contact between the bipolar plates.

### DETAILED DESCRIPTION OF THE PREFERRED EMBODIMENTS

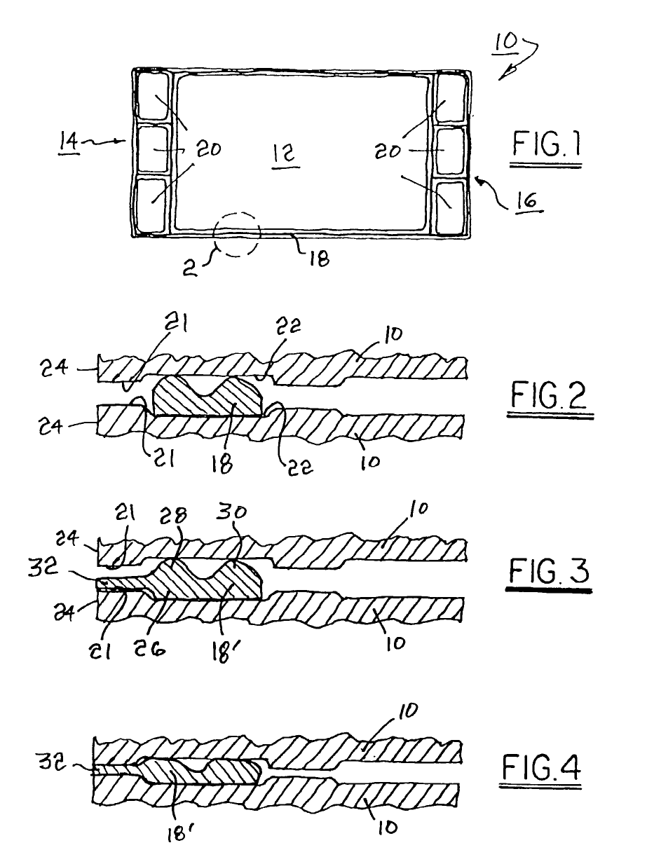

Referring to FIG. 1, a typical bipolar plate 10 for use in a PEM fuel cell is generally rectangular, having a central region 12 for receiving a fuel cell module (not shown) and first and second manifold regions 14,16 for providing fuel and air to the central region in known fashion. Plate 10 is provided with a known resilient gasket 18, typically formed as a single element, which surrounds central region 12 and one or more of the apertures 20 in manifold regions 14 and 16.

Referring to FIG. 2, when two such bipolar plates 10 are adjoined in a fuel cell stack, gasket 18 seals the plates so that reactants do not leak and prevents the plates from contacting each other.

The surfaces 21 of the plates preferably include a shallow well 22 slightly inboard of the plate edge 24 for retaining the gasket and for permitting use of a relatively thick gasket which is easy to manufacture and install. While a shallow well is described and shown herein at the outer portions of the plates, it should be understood by one of skill in the art that, within the scope of the invention, surface 21 can take any convenient configuration for accommodating a gasket or have no well-like configuration at all. Further, for the purpose of retaining the gasket in place, the gasket may be bonded to the plate instead by, for example, adhesive as known in the art.

Referring to FIGS. 3 and 4, an improved gasket 18′ includes a base portion 26 supporting, in the example shown, first and second ribs 28,30 that rise axially of plates 10 for primary sealing of the plates to each other. Gasket 18′ may be formed of any non-reactive resilient material. It is also understood that one, or any number of gasket ribs can be used for sealing. Some deformability is necessary to allow the gasket to accomplish the function of sealing the plates, although if the material is too deformable, plates 10 may come into contact each other as described hereinabove, shorting out the fuel cell. Such materials can include, but are not limited to asbestos, plastic, polyisoprene rubber, silicone rubber, polyurethane, or other rubber materials, or any combination thereof. Preferably, gasket 18′ is formed of a rubber material to allow the gasket to effect a primary seal between plates 10.

A resilient flange 32, preferably integral with gasket 18′, extends circumferentially outward of ribs 28,30 between outer surface portions 21 of plate 10. Flange 32 is thinner than the height of ribs 28,30, and preferably less than the compressed thickness of the gasket, so as not to interfere with the stacking or performance of the fuel cell stack. Flange 32 may extend through only a small portion of the gap between surface portions 21 plates or may extend to or beyond the edges 24 of the plates. The flange may be formed of the same material as the gasket, and may also be formed of a different material such as a rigid plastic or the like. The purpose of flange 32 is to limit the approach of one bipolar plate to another, as shown in FIG. 4, and thereby prevent electrical transmission between plates 10 in the region of surface portions 21. Flange 32 is not required for primary sealing between the plates. The flange may be made through any manufacturing process that will produce a gasket and flange assembly such as that described herein, for example, injection or compression molding. The gasket and flange may also be extruded in liquid resin form onto the bipolar plate and allowed to polymerize or otherwise set in situ. The flange may be integral with or separate from gasket 18′. The flange can be made from any non-reactive material such as, but are not limited to asbestos, plastic, polyisoprene rubber, silicone rubber, polyurethane, or other rubber materials, or any combination thereof. It is recommended that the gasket and flange be made from a dielectric rubber material to allow the gasket to function both as an insulative spacer between the plates and a seal to prevent the reactants from leaking.

A flange integral with a gasket in accordance with the invention enhances the planarity of the gasket and thus reduces difficulty of installing the gasket during assembly.

While the embodiment shown in the drawings depict the edge of flange 32 to be flush with the edges 24 of plates 10, it is understood that the flange edge can extend beyond the edges of the plates and be within the scope of the invention.

While the embodiment shown and described depicts the plate sealing means as one or more ribs, it is understood that the plate sealing means includes other methods of sealing such as, for example, a resilient flat gasket without ribs.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A bipolar plate for use in a fuel cell assembly, comprising:
a) a substantially planar element receivable of a fuel cell module;
b) a compressible gasket disposed on a surface of said planar element at a distance inboard of an edge of said element; and
c) a dielectric flange disposed on said surface between said gasket and said edge for preventing electrical contact with an adjacent bipolar plate in said fuel cell assembly.

2. A bipolar plate in accordance with claim 1 wherein said flange is formed integrally with said gasket.

3. A bipolar plate in accordance with claim 1 wherein said surface is provided with a shallow well for receiving said gasket.

4. A bipolar plate in accordance with claim 1 wherein said gasket is formed of a resilient material.

5. A bipolar plate in accordance with claim 4 wherein said material is selected from the group consisting of asbestos, plastic, polyisoprene rubber, silicone rubber, polyurethane, and any combination thereof.

6. A bipolar plate in accordance with claim 1 wherein said flange has a thickness less than the compressed thickness of the gasket.

7. A fuel cell assembly comprising at least one bipolar plate, wherein said bipolar plate includes,
a substantially planar element receivable of a fuel cell module,
a compressible gasket disposed on a surface of said planar element at a distance inboard of an edge of said element, and
a dielectric flange disposed on said surface between said gasket and said edge for preventing electrical continuity with an adjacent bipolar plate in said fuel cell assembly.

8. A gasket for separating and sealing adjacent bipolar plates in a fuel cell assembly, comprising:
a) a base portion;
b) at least one rib supported by said base portion and extending axially of said fuel cell assembly for forming a seal with an adjacent bipolar plate; and
c) a dielectric flange extending from said base portion circumferentially outward of said at least one rib of said fuel cell assembly for preventing electrical contact between said adjacent bipolar plates.
